(19) United States
(12) Patent Application Publication
(10) Pub. No.: US 2024/0172255 A1
(43) Pub. Date: May 23, 2024

(54) SYSTEMS AND METHODS FOR PERFORMING SIDELINK DRX

(71) Applicant: ZTE Corporation, Shenzhen (CN)

(72) Inventors: Wei LUO, Shenzhen (CN); Weiqiang DU, Shenzhen (CN); Lin CHEN, Shenzhen (CN)

(73) Assignee: ZTE Corporation, Shenzhen (CN)

(21) Appl. No.: 18/428,082

(22) Filed: Jan. 31, 2024

Related U.S. Application Data
(63) Continuation of application No. PCT/CN2021/110866, filed on Aug. 5, 2021.

(51) Int. Cl. H04W 72/40; H04W 76/28; H04W 88/04; H04W 92/18

(52) U.S. Cl. CPC H04W 72/40; H04W 76/28; H04W 88/04; H04W 92/18

(57) ABSTRACT

In some aspects, a wireless communication method includes: determining, by a wireless communication device, whether at least one of a dedicated resource pool or a number of shared resource pools is provided, wherein each of the shared resource pools includes a sidelink transmission or reception resource pool; and performing, by the wireless communication device, sidelink discovery using the dedicated resource pool or one of the shared resource pools being provided based on its configuration.

### CROSS-REFERENCE TO RELATED APPLICATION

This application claims the benefit of priority under 35 U.S.C. § 120 as a continuation of PCT Patent Application No. PCT/CN2021/110866, filed on Aug. 5, 2021, the disclosure of which is incorporated herein by reference in its entirety.

### TECHNICAL FIELD

The disclosure relates generally to wireless communications and, more particularly, to systems and methods for configuring discontinuous reception for sidelink transmission between communication terminals.

### BACKGROUND

Sidelink (SL) communication is a wireless radio communication directly between two or more user equipment devices (hereinafter “UE”). In this type of communication, two or more UEs that are geographically proximate to each other can directly communicate without going through a base station (hereinafter “BS”). Data transmission in sidelink communications is thus different from typical cellular network communications, which transmit data to a BS (i.e., uplink transmissions) or receive date from a BS (i.e., downlink transmissions). In sidelink communications, data is transmitted directly from a source UE to a target UE through the Unified Air Interface, e.g., PC5 interface, without passing through a BS.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some aspects, a wireless communication method includes: determining, by a wireless communication device, whether at least one of a dedicated resource pool or a number of shared resource pools is provided, wherein each of the shared resource pools includes a sidelink transmission or reception resource pool; and performing, by the wireless communication device, sidelink discovery using the dedicated resource pool or one of the shared resource pools being provided based on its configuration.

In some aspects, the method includes determining, by the wireless communication device, that no dedicated resource pool is provided; determining, by the wireless communication device, that the shared resource pool being provided is configured to perform the sidelink discovery; and performing, by the wireless communication device, the sidelink discovery using the shared resource pool.

In some aspects, a wireless communication method includes: identifying, by a wireless communication device, a plurality of conditions comprising: Ms1+Hys1< or >Thresh1; Ms1< or >Thresh1; Ms2−Hys2> or <Thresh2; Ms2> or <Thresh2, wherein Ms1 represents a Channel Busy Ratio (CBR) sidelink measurement result, Ms2 represents a Reference Signal Received Power (RSRP) sidelink measurement result, Hys1 represents a hysteresis parameter for CBR, Hys2 represents a hysteresis parameter for RSRP, Thresh1 represents a CBR threshold, and Thresh2 represents a RSRP threshold; and determining, by the wireless communication device, based on at least one of the conditions being satisfied, whether or not to perform measurements for a Uu link; wherein the wireless communication device is a sidelink remote User Equipment (UE) connected to a sidelink relay UE.

In some aspects, identifying, by the wireless communication device, that at least one of the following conditions is satisfied: Ms1<Thresh1; Ms2−Hys2>Thresh2; or Ms2>Thresh2; and determining, by the wireless communication device, not to perform the measurements for the Uu link.

In some aspects, a wireless communication method includes: identifying, by a wireless communication device, a sidelink Conditional Handover (CHO) configuration that includes one or more CHO candidate cells or CHO candidate relay UEs, and a plurality of conditions comprising: a sidelink relay becomes worse than a first threshold and a serving cell or neighboring cell becomes better than a second threshold; the sidelink relay becomes better than the first threshold and the serving cell or neighboring cell becomes worse than the second threshold; the serving cell or neighboring cell becomes an amount of offset better than the sidelink relay; the sidelink relay becomes an amount of offset better than the serving cell or neighboring cell; a sidelink RLF is detected; and a sidelink RLF indication is received; and determining, by the wireless communication device, based on at least one of the conditions being satisfied, to perform a CHO procedure; wherein the wireless communication device is a sidelink remote User Equipment (UE) connected to a sidelink relay UE. In some aspects, a priority parameter is configured for each of the CHO candidate cells or each of the CHO candidate relay UEs.

In some aspects, a wireless communication method includes: receiving, by a wireless communication device from a wireless communication node, Discontinuous Reception (DRX) configuration; wherein the DRX configuration indicates at least one of: whether or not the wireless communication device should report sidelink DRX assistant information of one or more peer wireless communication devices to the wireless communication node; or whether or not the wireless communication device should decide DRX parameters of one or more peer wireless communication devices by itself.

In some aspects, a wireless communication method includes: receiving, by a first wireless communication device from a second wireless communication device, sidelink DRX assistant information; determining, by the first wireless communication device, sidelink DRX configuration for the second wireless communication device based on the sidelink DRX assistant information; and sending, by the first wireless communication device to the second wireless communication device, the sidelink DRX configuration.

In some aspects, if the second wireless communication device determines that the SL DRX configuration cannot be accepted, it can send the information to reject this SL DRX configuration. And it continues to use the SL DRX configuration used before. For example, if the first wireless communication device has configured a valid SL DRX for the Rx UE prior to corresponding SL DRX configuration message, the second wireless communication shall continue to use this valid SL DRX configuration, otherwise, the second wireless communication shall use the suggested DRX configuration carried in the sidelink DRX assistant information.

In some aspects, the sidelink DRX assistant information includes one or more DRX cycles, the method further comprises: selecting, by the first wireless communication device, one of the one or more DRX cycles provided in the sidelink DRX assistant information.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, in accordance with an embodiment of the present disclosure.

FIG. 2 illustrates another example wireless communication network, in accordance with some embodiments of the present disclosure.

FIG. 3 illustrates a method for performing sidelink discovery, in accordance with some embodiments.

FIG. 4 illustrates a method for determining whether to perform measurements for a Uu link, in accordance with some embodiments.

FIG. 5 illustrates a method for determining to perform a CHO procedure, in accordance with some embodiments.

FIG. 6 illustrates a method for receiving a Discontinuous Reception (DRX) configuration, in accordance with some embodiments.

FIG. 7 illustrates a method for determining sidelink DRX configuration, in accordance with some embodiments.

FIG. 8 illustrates an end-to-end control plane for a remote UE using layer-2 UE-to-network relay, in accordance with some embodiments.

FIG. 9 illustrates end-to-end quality of service (QOS) translation for Layer 3 UE-to-network relay, in accordance with some embodiments.

### DETAILED DESCRIPTION OF EXAMPLE EMBODIMENTS

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

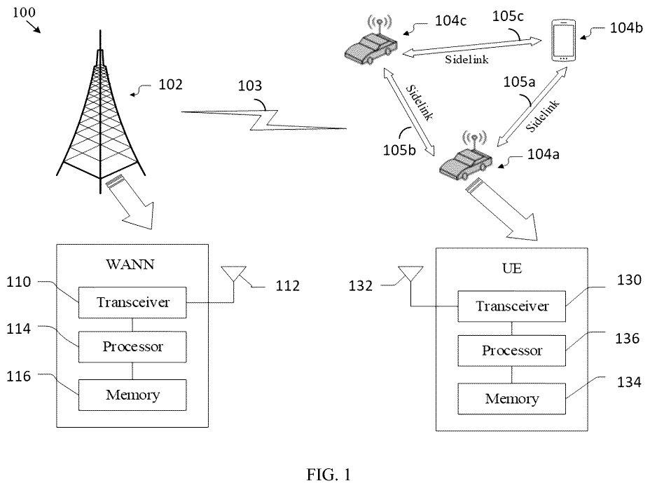

Referring to FIG. 1, an example wireless communication network 100 is shown. The wireless communication network 100 illustrates a group communication within a cellular network. In a wireless communication system, a network side communication node or a base station (BS) can include a next Generation Node B (gNB), an E-utran Node B (also known as Evolved Node B, eNodeB or eNB), a pico station, a femto station, a Transmission/Reception Point (TRP), an Access Point (AP), or the like. A terminal side node or a user equipment (UE) can include a long range communication system such as, for example, a mobile device, a smart phone, a personal digital assistant (PDA), a tablet, a laptop computer, or a short range communication system such as, for example a wearable device, a vehicle with a vehicular communication system, or the like. In FIG. 1, a network side and a terminal side communication node are represented by a BS 102 and a UE 104a, 104b, or 104c, respectively, and in the embodiments in this disclosure hereafter. In some embodiments, the BS 102 and UE 104a/104b/104c are sometimes referred to as “wireless communication node” and “wireless communication device,” respectively. Such communication nodes/devices can perform wireless and/or wired communications.

In the illustrated embodiment of FIG. 1, the BS 102 can define a cell in which the UEs 104a-b are located. The UE 104a can include a vehicle that is moving within a coverage of the cell. The UE 104a can communicate with the BS 102 via a communication channel 103. Similarly, the UE 104b or 104c can communicate with the BS 102 via a communication channel 103. In addition, the UEs 104a-c can communicate with each other via a communication channel 105a (between 104a and 104b), 105b (between 104a and 104c), and 105c (between 104b and 104c). The communication channels (e.g., 103) between the UE and the BS can be through interfaces such as an Uu interface, which is also known as UMTS (Universal Mobile Telecommunication System (UMTS))air interface. The communication channels (e.g., 105a-c) between the UEs can be through a PC5 interface, which is introduced to address high moving speed and high density applications such as, for example, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, such car network communications modes can be collective referred to as Vehicle-to-Everything (V2X) communications. It is appreciated that the communications channels between the UEs can be used in Device-to-Device (D2D) communications while remaining within the scope of the present disclosure. The BS 102 is connected to a core network (CN) through an external interface, e.g., an Iu interface.

The BS 102 includes a BS transceiver module 110, a BS antenna 112, a BS memory module 116, a BS processor module 114, and a network communication module, each module being coupled and interconnected with one another as necessary via a data communication bus. The UE 104a includes a UE transceiver module 130, a UE antenna 132, a UE memory module 134, and a UE processor module 136, each module being coupled and interconnected with one another as necessary via a data communication bus. Similarly, the UE 104b includes a UE transceiver module similar to that of UE 104a. The BS 102 communicates with the UEs 104a-b via one or more of a communication channel 150, which can be any wireless channel or other medium known in the art suitable for transmission of data as described herein.

As would be understood by persons of ordinary skill in the art, the BS 102 and the UE 104a may further include any number of modules other than the modules shown in FIG. 1. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a-c to an antenna of the BS 102 is known as an uplink transmission, and a wireless transmission from an antenna of the BS 102 to an antenna of one of the UEs 104a-c is known as a downlink transmission. In accordance with some embodiments, each of the UE transceiver modules (e.g., the transceiver module 130) may be referred to herein as an uplink transceiver, or UE transceiver. The uplink transceiver can include a transmitter and receiver circuitry that are each coupled to the respective antenna (e.g., the antenna 132). A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and the uplink/UE transceivers are coordinated in time such that the uplink receiver is coupled to the UE antennas for reception of transmissions over the wireless communication channel at the same time that the downlink transmitter is coupled to the antenna 112. In some embodiments, the UEs 104a-c can use the UE transceivers through the respective antennas 132 to communicate with the BS 102 via the wireless communication channel. The wireless communication channel can be any wireless channel or other medium known in the art suitable for downlink (DL) and/or uplink (UL) transmission of data as described herein. The UEs 104a-c can communicate with each other via a wireless communication channel. The wireless communication channel can be any wireless channel or other medium known in the art suitable for sidelink transmission of data as described herein.

Each of the UE transceivers and the BS transceiver 110 are configured to communicate via the wireless data communication channel, and cooperate with a suitably configured antenna arrangement that can support a particular wireless communication protocol and modulation scheme. In some embodiments, the UE transceivers and the BS transceiver 110 are configured to support industry standards such as the Long Term Evolution (LTE) and emerging 5G standards, or the like. It is understood, however, that the present disclosure is not necessarily limited in application to a particular standard and associated protocols. Rather, the UE transceivers and the BS transceiver 110 may be configured to support alternate, or additional, wireless data communication protocols, including future standards or variations thereof.

The UE processor modules (e.g., the processor module 136) and the BS processor module 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 114 and the UE processor modules, respectively, or in any practical combination thereof. The memory modules 116 and the UE memory modules (e.g., the memory module 134) may be realized as RAM memory, flash memory, ROM memory, EPROM memory, EEPROM memory, registers, a hard disk, a removable disk, a CD-ROM, or any other form of storage medium known in the art. In this regard, the memory modules 116 and the UE memory modules may be coupled to the processor modules 114 and the UE processor modules, respectively, such that the processors modules 114 and the UE processor modules can read information from, and write information to, memory modules 116 and the UE memory modules, respectively. The memory modules 116 and the UE memory modules may also be integrated into their respective processor modules 114 and the UE processor modules. In some embodiments, the memory modules 116 and the UE memory modules may each include a cache memory for storing temporary variables or other intermediate information during execution of instructions to be executed by processor modules 114 and the UE processor modules, respectively. Memory modules 116 and the UE memory modules may also each include non-volatile memory for storing instructions to be executed by the processor modules 114 and the UE processor modules, respectively.

The network interface/communication module generally represents the hardware, software, firmware, processing logic, and/or other components of the BS 102 that enable bi-directional communication between BS transceiver 110 and other network components and communication nodes configured to communication with the BS 102. For example, the network interface may be configured to support internet or WiMAX traffic. In a typical deployment, without limitation, the network interface provides an 802.3 Ethernet interface such that BS transceiver 110 can communicate with a conventional Ethernet based computer network. In this manner, the network interface may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface can allow the BS 102 to communicate with other BSs or core network over a wired or wireless connection.

In some embodiments, each of the UEs 104a-c can operate in a hybrid communication network in which the UE communicates with the BS 102, and with other UEs, e.g., between 104a and 104b. As described in further detail below, the UEs 104a-c support sidelink communications with other UE's as well as downlink/uplink communications between the BS 102 and the UEs 104a-c. In general, the sidelink communication allows the UEs 104a-c to establish a direct communication link with each other, or with other UEs from different cells, without requiring the BS 102 to relay data between UEs.

Out of coverage UEs are unable to derive TDD UL-DL configuration information since they cannot receive the configuration signal from network. Consequently, out of coverage UEs cannot know the frame structure in the shared carrier with cellular Uu link. And cannot know the location of sidelink resource pool. So, the out of coverage UEs cannot perform sidelink communication (e.g., V2X) with the in coverage UEs. By configuring and pre-configuring, TDD UL-DL configuration information can be aligned between out of coverage and in coverage. But this would restrict the configuration from network.

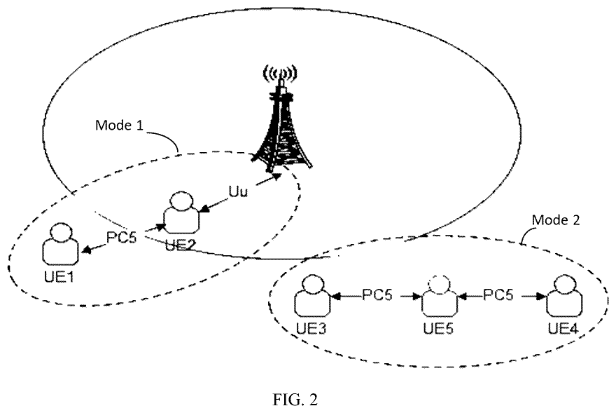

Referring to FIG. 2, an example wireless communication network 200 is shown. The network 200 includes a gNB/eNB, an in coverage UE (UE2) in communication with the gNB/eNB, and an out of coverage UE (UE1) in sidelink communication with the in coverage UE. In some embodiments, the gNB/eNB is BS 102 with respect to FIG. 1, the in coverage UE (UE2) is one of UE 104a, 104b, or 104c with respect to FIG. 1, and the out of coverage UE (UE1) is another of UE 104a, 104b, or 104c with respect to FIG. 1, except that the out of coverage UE is not in communication with the gNB/eNB. The network 200 can be referred to as partial coverage. Partial coverage is a scenario in which both in coverage UEs and out of coverage UEs are included. In coverage UEs and out of coverage UEs can work (e.g., perform, communicate) in different carriers. For example, the out of coverage UEs can perform V2X communication in a dedicated carrier, e.g., a carrier in ITS (Intelligent Transport System) frequency and the in coverage UEs can perform V2X communication in a shared carrier, e.g., the carrier for Uu link. In coverage UEs and out of coverage UEs can work in same carriers, such as in dedicated carrier or shared carrier. When the in coverage UEs and the out of coverage UEs work in the same carrier, the frame structure information is same for the in coverage UEs and the out of coverage UEs. Otherwise, they may or may not perform V2X communication with each other successfully. If the out of coverage UEs perform V2X communication with the in coverage UEs in the shared carrier, they keep the frame structure aligned TDD UL-DL configuration information configured in coverage. They may or may not impact the cellular communication, e.g., UL transmission.

In LTE V2X, TDD UL-DL configuration information is carried in PSBCH (Physical Sidelink Broadcast Channel) to indicate the frame structure information of the shared carrier for the out of coverage UEs. A total 7 kinds of TDD UL-DL configurations are supported in LTE, such that 3 bits are enough to indicate the kind of TDD UL-DL configuration.

In NR system, TDD UL-SL configuration information includes a cell-specific frame structure configuration (e.g., tdd-UL-DL-ConfigurationCommon), a UE-specific frame structure configuration (e.g., tdd-UL-DL-ConfigurationDedicated) and a Group-common frame structure configuration (e.g., DCI format 2_0). In NR V2X, only the cell-specific frame structure configuration information is indicated in PSBCH.

### B. Performing Sidelink DRX

For sidelink communication, including v2x communication, a user equipment (UE, e.g., the UE 104, the UE1, the UE2, a mobile device, a wireless communication device, a terminal, etc.) may need to monitor sidelink signals within the whole sidelink receiving resource pool, which has huge power consumption and low efficiency. Based on this problem, the disclosure proposes embodiments of a solution to ensure delay demand and save power consumption. Some embodiments of the solution include optimizing SL DRX technology and reducing a measurement power consumption of remote UE. In addition, for the sidelink relay scenario, a scheme to reduce the service delay is proposed.

Sidelink is a unilateral wireless communication service, e.g., a communication between communication terminal/UEs. Vehicle networking refers to a large scale system for wireless communication and information exchange among vehicles, pedestrians, roadside equipment, and internet in accordance with agreed communication protocols and data exchange standards. The vehicle networking communications enable the vehicles to gain driving safety, improve traffic efficiency, and acquire convenience or entertainment information. The vehicle networking communication may be categorized into three types as per the objects of wireless communication: the communication between vehicles, i.e., vehicle-to-vehicle (V2V); the communication between vehicles and roadside equipment/network infrastructures, i.e., vehicle-to-infrastructure/vehicle-to-network (V2I/V2N); and the communication between vehicles and pedestrians, i.e., vehicle-to-pedestrian (V2P). These types of communications collectively are referred to as vehicle-to-everything (V2X) communication.

In the V2X communication research of 3rd Generation Partnership Project (3GPP), the sidelink-based V2X communication method between user equipment is one of the manners to implement the V2X standard, in which traffic data is directly transmitted from a source user equipment to a destination user equipment via an air interface without forwarding by a base station (BS, e.g., the BS 102, a wireless communication node, a Next Generation NodeB (gNB), an Evolved NodeB (eNB), a cell, a cell tower, a radio access device, a transmit receive point (TRP), etc.) and the core network, as shown in FIG. 1. This V2X communication is referred to as PC5-based V2X communication or V2X sidelink communication.

With the technology advancement and development of the automation industry, the scenarios for V2X communications are further diversified and require higher performance. The advanced V2X services include vehicle platooning, extended sensors, advanced driving (semi-automated driving and full-automated driving), and remote driving. The desired performance requirements may include: supporting data packet with the size of 50 to 12000 bytes, transmission rate with 2 to 50 messages per second, the maximum end-to-end delay of 3 to 500 milliseconds, reliability of 90% to 99.999%, data rate of 0.5 to 1000 Mbps, as well as transmission range of 50 to 1000 meters.

Disclosed herein are embodiments of determining how to use a relay discovery resource pool. In some embodiments, if a dedicated sidelink discovery resource pool is provided, the network provides a Channel Busy Ratio (CBR) threshold, and the CBR of the Dedicated sidelink discovery resource pool is lower than the configured CBR threshold, the UE can use the dedicated sidelink discovery resource pool for sidelink discovery and cannot use the shared sidelink discovery resource pool for sidelink discovery.

In some embodiments, for a UE that is a remote UE and is connected with a relay UE, if at least one of (a) Ms1+Hys1<Thresh1 (b) Ms1<Thresh1, (c) Ms2−Hys2>Thresh2, or (d) Ms2>Thresh2 is fulfilled, then the UE may choose not to perform (e.g., intra-frequency) measurements for Uu link.

In some embodiments, a sidelink conditional handover (CHO) configuration contains a configuration of CHO candidate cell(s) and execution condition(s). An execution condition/event may include one or more trigger condition(s) such as that (a) a sidelink relay becomes/is worse than absolute threshold1 and a primary cell (PCell)/primary secondary cell (PSCell) becomes (e.g., is) better than another absolute threshold2, (b) the PCell/PSCell becomes an amount of offset better than the sidelink relay, (c), a sidelink radio link failure (RLF) is detected, or (d) an RLF indication is received from the sidelink relay.

In some embodiments, the network (e.g., the BS) indicates whether the UE is to report SL DRX assistant information of a peer UE (e.g., a second UE) to the network or whether the UE is to decide the SL DRX of the peer UE by its own. In some embodiments, the second UE determines some parameters of SL DRX according to the specified rules and determines other parameters of SL DRX via a UE implementation.

A sidelink relay or remote UE may be configured with both dedicated sidelink discovery resource pool and shared sidelink discovery resource pool. In some embodiments, if a dedicated sidelink discovery resource pool is provided, the UE is to use the dedicated sidelink discovery resource pool to perform sidelink discovery.

There is a number of embodiments where the UE is to use shared resource pool for sidelink discovery. In some embodiments, if the dedicated sidelink discovery resource pool is not provided, and the network allows sidelink discovery transmission, then any shared sidelink resource pool can be used for sidelink discovery. In some embodiments, if the dedicated sidelink discovery resource pool is provided, then any shared sidelink resource pool cannot be used for sidelink discovery.

In some embodiments, if the dedicated sidelink discovery resource pool is not provided, and the network indicates which shared sidelink resource pool can be used for sidelink discovery, for example, if a ‘sidelink relay allowed’ indication is included in the configuration information element (IE) for a first sidelink resource pool, then the first sidelink resource pool can be used for sidelink discovery. In some embodiments, if the ‘sidelink relay allowed’ indication is not included in the configuration IE or if a ‘sidelink relay is not allowed’ indication is included in the configuration IE for a second sidelink resource pool, then the second sidelink resource pool cannot be used for sidelink discovery.

In some embodiments, if the dedicated sidelink discovery resource pool is provided, and the network indicates which shared sidelink resource pool can be used for the sidelink discovery, for example, if a ‘sidelink relay allowed’ indication is included in the configuration IE for a first sidelink resource pool, then the first sidelink resource pool can be used for sidelink discovery. In some embodiments, if the ‘sidelink relay allowed’ indication is not included in the configuration IE or if a ‘sidelink relay is not allowed’ indication is included in the configuration IE for a second sidelink resource pool, the second sidelink resource pool cannot be used for sidelink discovery.

In some embodiments, if the dedicated sidelink discovery resource pool is provided, the network provides the CBR threshold, and the CBR of the dedicated sidelink discovery resource pool is lower than the configured CBR threshold, then the UE can use the dedicated sidelink discovery resource pool for the sidelink discovery and cannot use the shared sidelink discovery resource pool for the sidelink discovery.

In some embodiments, if the CBR of the dedicated sidelink discovery resource pool is higher than the configured CBR threshold, the UE may not use the dedicated sidelink discovery resource pool for sidelink discovery, and the UE can use the shared sidelink discovery resource pool for the sidelink discovery. In some embodiments, if the multiple shared sidelink resource pools are configured, the network indicates which shared sidelink resource pool can be used for sidelink discovery.

In some embodiments, if the shared sidelink discovery resource pool is provided, the network provides the CBR threshold for any of the shared sidelink discovery resource pools, and the CBR of any of the shared sidelink discovery resource pool is lower than the configured CBR threshold, then the UE can use the shared sidelink discovery resource pool for sidelink discovery. In some embodiments, if the CBR of the shared sidelink discovery resource pool is higher than the configured CBR threshold, the UE may not use the shared sidelink discovery resource pool for sidelink discovery. In some embodiments, if the dedicated sidelink discovery resource pool is provided, the UE can use dedicated sidelink discovery resource pool for the sidelink discovery.

In some embodiments, there may be only one CBR threshold used for all the shared resource pools. In some embodiments, there may be multiple CBR thresholds and each CBR threshold associated with one shared resource pool.

In some embodiments of wireless communication systems, a base station-centric cellular network has limitations in terms of high data rate and proximity service support. Device-to-device (D2D) communication technology may address some of these limitations. In addition to communicating directly with a target node (such as a base station or other mobile terminals), the UE can also realize data transmission with the target node through bypass-based relay devices. Thus, some embodiments support a wider range of applications and services, expanding coverage and improving power consumption, improved robustness of network infrastructure, and the requirements of high data rate services and proximity services. D2D technology may be referred to as called proximity services (ProSe) or unilateral/sidelink (SL) communication. In some embodiments, the interface between the device and the device is a direct link PC5 interface.

As shown in FIG. 2, in some embodiments, applications of a sidelink relay communication include 1) relay transmission between UE and base station, and UE relay transmission in weak/no coverage area, and 2) UE Relay transmission with UE. Mode 1 in FIG. 2 is an example of relay transmission between UE and base station, and UE relay transmission in weak/no coverage area. In some embodiments, mode 1 allows UE1 with poor signal quality or without coverage to communicate with the network through UE2 with network coverage nearby. In some embodiments, communicating through another UE (UE2) is helpful for operators to expand coverage and increase capacity. In some embodiments, UE2 is a relay device, that is, UE-to-Network relay.

Mode 2 in FIG. 2 is an example of UE relay transmission with UE. In some embodiments, mode 2 allows devices to communicate through a relay UE in the event of an earthquake or emergency (e.g., in which the cellular network may not work normally/goes down) or in order to expand the sidelink communication range. In some embodiments, UE3 and UE4 can perform data communication through UE5 or a multi-hop relay UE, using UE-to-UE relay. In some embodiments, UE5 is a relay device.

In embodiments lacking the improvements disclosed herein, there is no effective mechanism to determine a communication link between the UE and a target node, which cannot adapt to different actual network conditions, resulting in business interruption, poor service quality, and a low reliability of the communication link.

Some embodiments provide two UE-to-Network relay based on the internet protocol (IP) layer (Layer 3) and the access layer (Layer 2). In some embodiments, relay transmission of layer 3 (IP layer) includes forwarding of data based on information such as the target IP address/port number. In some embodiments, relay transmission of layer 2 (access layer) includes performing, by the relay UE, the control plane at the access layer. In some embodiments, the routing and forwarding of user plane data enables operators (i.e., core network elements and base stations) to manage remote equipment (Remote UE) more effectively. However, differences between New Radio (NR) Sidelink communication and LTE sidelink communication mechanisms, include frame structure, quality of service (QOS) processing, bearer configuration and establishment, etc. In some embodiments, LTE-based Sidelink relay transmission is not suitable for 5G or New Radio (NR) system.

In some embodiments, for a (e.g., normal) UE, cell selection is performed by one of a) initial cell selection (e.g., no prior knowledge of which RF channels are NR frequencies) or b) cell selection by leveraging stored information. In some embodiments, initial cell selection includes a) scanning, by the UE, all RF channels in the NR bands according to its capabilities to find a suitable cell, b) (e.g., only) searching, by the UE, on each frequency, for the strongest cell, and c) selecting, by the UE, the suitable cell once it is found.

In some embodiments, cell selection by leveraging stored information includes a) using stored information of frequencies (e.g., and information on cell parameters from previously received measurement control information elements or from previously detected cells), b) selecting, by the UE, the suitable cell once it is found, and c) If no suitable cell is found, starting the initial cell selection procedure.

The cell selection criterion S is fulfilled when:
Srxlev>0 AND Squal>0, wherein
Srxlev=Qᵣₓₗₑᵥₘₑₐₛ−(Qᵣₓₗₑᵥₘᵢₙ+Q_{rxlevminoffset})−P_{compensation}−Q_{offsettemp}, and
Squal=Q_{qualmeas}−(Q_{qualmin}+Q_{qualminoffset})−Q_{offsettemp}, wherein

| | |
|---|---|
| Srxlev | Cell selection RX level value (dB) |
| Squal | Cell selection quality value (dB) |
| Qoffsetₜₑₘₚ | Offset temporarily applied to a cell (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports supplementary uplink (SUL) frequency for this |
| | cell, Qᵣₓₗₑᵥₘᵢₙ is obtained from q-RxLevMinSUL, if |
| | present, in SIB1, SIB2 and SIB4, additionally, if |
| | Q_{rxlevminoffsetcellSUL} is present in SIB3 and SIB4 for the |
| | concerned cell, this cell specific offset is added to the |
| | corresponding Qᵣₓₗₑᵥₘᵢₙ to achieve the required minimum |
| | RX level in the concerned cell; |
| | else Qᵣₓₗₑᵥₘᵢₙ is obtained from q-RxLevMin in SIB1, SIB2 |
| | and SIB4, additionally, if Q_{rxlevminoffsetcell} is present in SIB3 |
| | and SIB4 for the concerned cell, this cell specific offset is |
| | added to the corresponding Qᵣₓₗₑᵥₘᵢₙ to achieve the |
| | required minimum RX level in the concerned cell. |
| Q_{qualmin} | Minimum required quality level in the cell (dB). |
| | Additionally, if Q_{qualminoffsetcell} is signaled for the |
| | concerned cell, this cell specific offset is added to achieve |
| | the required minimum quality level in the concerned cell. |
| Q_{rxlevminoffset} | Offset to the signaled Qᵣₓₗₑᵥₘᵢₙ taken into account in the |
| | Srxlev evaluation as a result of a periodic search for a |
| | higher priority PLMN while camped normally in a |
| | VPLMN. |
| Q_{qualminoffset} | Offset to the signaled Q_{qualmin} taken into account in the |
| | Squal evaluation as a result of a periodic search for a |
| | higher priority PLMN while camped normally in a |
| | VPLMN. |
| P_{compensation} | If the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| P_{EMAX1}, P_{EMAX2} | Maximum TX power level of a UE may use when |
| | transmitting on the uplink in the cell (dBm) defined as |
| | P_{EMAX}. If UE supports SUL frequency for this cell, |
| | P_{EMAX1} and P_{EMAX2} are obtained from the p-Max for SUL |
| | in SIB1 and NR-NS-PmaxList for SUL respectively in |
| | SIB1, SIB2 and SIB4, else P_{EMAX1} and P_{EMAX2} are |
| | obtained from the p-Max and NR-NS-PmaxList |
| | respectively in SIB1, SIB2 and SIB4 for normal UL. |
| P_{PowerClass} | Maximum RF output power of the UE (dBm) according |
| | to the UE power class. |

For a (normal) UE, if the serving cell fulfils Srxlev>S_{IntraSearchP} and Squal>S_{IntraSearchQ}, the UE may choose not to perform (e.g., intra-frequency) measurements. Otherwise, the UE is to perform (e.g., intra-frequency) measurements.

In some embodiments, a UE is a remote UE and is connected with a relay UE, if one of following condition is fulfilled or all of the following conditions are fulfilled: Ms1+Hys1<Thresh1 or Ms1<Thresh1, Ms2 Hys2>Thresh2 or Ms2>Thresh2

The variables in the formula are defined as follows: Ms is the NR sidelink measurement result for CBR, Ms2 is the NR sidelink measurement result for RSRP, Hys1 is the hysteresis parameter for CBR, Hys1 is the hysteresis parameter for RSRP, Thresh1 is the threshold parameter for CBR, Thresh2 is the threshold parameter for RSRP, Thresh is expressed in the same unit as Ms. Then, the UE may choose not to perform measurements for Uu link.

In some embodiments, if Ms1+Hys1>Thresh1 or Ms1>Thresh1 for the remote UE, the UE is to perform measurements for Uu link. In some embodiments, if Ms2 Hys2<Thresh2 or Ms2<Thresh2, the UE is to perform measurements for Uu link. In some embodiments, if a remote UE receives a sidelink RLF indication from the relay UE, it is to perform measurements for Uu link. In some embodiments, if a remote UE detects SL RLF, it is to perform measurements for Uu link.

In some embodiments, a sidelink conditional handover (CHO) is defined as a handover or a path switch that is executed by the UE when one or more handover execution conditions are met. In some embodiments, the UE starts evaluating the execution condition(s) upon receiving the CHO configuration and stops evaluating the execution condition(s) once a handover is executed (e.g., a legacy handover or conditional handover execution). In some embodiments, the path switch at least includes a switch from an indirect link to a direct link and a switch from a direct link to an indirect link. In some embodiments, a direct link refers to a UE being connected with/to a network directly (e.g., without a relay UE in between the UE and the network). In some embodiments, an indirect link refers to a UE being connected with/to a relay UE and the relay UE is connected with/to a network.

In some embodiments, if a UE is a remote UE and is connected with a relay, it receives a sidelink CHO configuration from the relay UE and the sidelink CHO configuration information is configured by the network or the relay UE. In some embodiments, the sidelink CHO configuration contains the configuration of CHO candidate cell(s) and execution condition(s). An execution condition may comprise one or more trigger condition(s), for example, (a) the sidelink relay becomes worse than absolute threshold 1 and PCell/PSCell becomes better than another absolute threshold2, (b) the PCell/PSCell becomes amount of offset better than Sidelink relay, (c) the sidelink RLF is detected, or (d) RLF indication is received from sidelink relay. In some embodiments, the PCell/PSCell is one of CHO candidate cell(s). In some embodiments, the CHO candidate cell(s) includes the serving cell of the remote UE and other cell. In some embodiments, the CHO candidate cell(s) can only be the serving cell of the remote UE. Then, in some embodiments, if the execution condition is fulfilled, the UE is to perform the CHO. For example, the UE synchronize to the target PCell/PSCell.

In some embodiments, if UE is a remote UE and is connected with network, the UE receives the sidelink CHO configuration from the network. In some embodiments, the sidelink CHO configuration contains the configuration of CHO candidate Relay UE(s) and execution condition(s). If CHO configuration contains the configuration of CHO candidate relay UE(s), (a) sidelink relay becomes better than absolute threshold1 and PCell/PSCell becomes worse than another absolute threshold2, (b) sidelink relay becomes amount of offset better than PCell/PSCell, or (c) RLF is detected. In some embodiments, the sidelink relay is one of CHO candidate Relay UE(s). In some embodiments, the PCell/PSCell is the serving cell of the remote UE. Then, in some embodiments, if the execution condition is fulfilled, the UE is to perform CHO procedure.

In some embodiments, the serving cell may be configured with a higher priority (or lower priority value) than the non-serving cell. In some embodiments, the relay UE belongs to the same serving cell may be configured with a higher priority (or lower priority value) than the relay UE belongs to the different cell. In some embodiments, if more than one of the CHO candidate cells or CHO candidate relay UEs meet the conditions, the UE chooses the CHO candidate cells or CHO candidate relay UEs with higher priority or with lower priority value.

In some embodiments, the CHO procedure refers to a conditional path switch. In some embodiments, for a direct link (e.g., a remote UE is connected with network directly) to indirect link (e.g., a remote UE is connected a relay and the relay is connected with network) path switch, if the conditional path switch triggered, the UE performs PC5 connection establishment with a relay UE. In some embodiments, for an indirect link to direct link path switch, if the conditional path switch triggered, the UE performs synchronization with a cell. In some embodiments, the sidelink relay UEs served by the CHO candidate cells can be the CHO candidate relay UEs. In some embodiments, if the conditional path switch triggered, the UE perform PC5 connection establish with a relay UE that served by the CHO candidate cells.

In the sidelink communication such as V2X communication between UEs, the UEs may need to frequently monitor a sidelink transmission resource pool of the UE, for example by way of sensing, so as to obtain sidelink transmission resource from the sidelink transmission resource pool, which incurs huge power consumption and low efficiency. In some embodiments, one of the objectives of the present disclosure is to reduce the power consumption of the UEs in sidelink transmission. For example, the UE may be configured with discontinuous reception (DRX). In some embodiments, the discontinuous reception conserves the battery of the user equipment. The user equipment and the network may negotiate phases in which data transfer occurs. During other times the user equipment may turn its receiver off and enters a low power state. In this way, the power consumption of the user equipment may be saved.

The first UE may receive a first DRX configuration information from the wireless network access node. For example, the first UE may receive the first DRX configuration information via a radio resource control (RRC) dedicated message or a broadcast message. The first discontinuous reception (DRX) configuration information includes at least one of an indication of whether the first UE is to report SL DRX assistant information of a peer UE to the network or an indication of whether the UE is to decide the SL DRX of peer UE by its own.

In some embodiments, the first UE receives a second DRX configuration information from a second user equipment such as peer UE. In some embodiments, if indicating that first UE is to report SL DRX assistant information of the peer UE to the network or the first UE is not allowed to decide the SL DRX of peer UE by its own, then the first UE acquires a DRX configuration scheme for sidelink communication between the first user equipment and a second user equipment from the network. Then, in some embodiments, the first UE sends the acquired DRX configuration scheme to the peer UE.

In some embodiments, if indicating that first UE is to not report SL DRX assistant information of peer UE to the network or the first UE is allowed to decide the SL DRX of peer UE by its own, Subsequently, then the first UE decides a DRX configuration scheme for sidelink communication between the first user equipment and a second user equipment based on the first DRX configuration information (e.g., and the second DRX configuration information if it is acquired). For example, when a Tx-UE is in-coverage and in RRC_CONNECTED state, if the Tx-UE reports the information received in signaling-1 (Rx->Tx) to the serving network, then the serving network can decide the SL DRX configuration for the Rx-UE.

In some embodiments, if the sidelink resource is allocated by the network for a Tx UE, the Tx-UE is to monitor the downlink control channel to perform sidelink transmission. Thus, in some embodiments, the DL DRX configuration of the Tx UE is to be coordinated with SL DRX configuration of the Rx UE. Given that the Uu DRX of an RRC_CONNECTED Tx UE is decided by the gNB, if the gNB decides the SL DRX configuration of RX UE, then the Uu DRX of Tx UE and SL DRX of Rx UE is aligned based on the network (NW) implementation. Thus, in some embodiments, it is beneficial for the serving cell of the Tx UE to determine the SL DRX configuration of the Rx UE. In some embodiments, if the Tx UE can select a sidelink resource by its own, it is beneficial for the TX UE to decide the SL DRX configuration of the RX UE.

Some embodiments of DRX include that (a) the first UE sends SL DRX configuration assistant information to a second UE (referred to as “step 1”), (b) the second UE decides the SL DRX configuration for the first UE (referred to as “step 2”), and (c) the second UE sends the SL DRX configuration to the first UE (referred to as “step3”).

In some embodiments, in step 1, the first UE sends SL DRX configuration Assistant information to a second UE. In some embodiments, the SL DRX configuration assistant information includes a SL DRX configuration request. In some embodiments, to avoid that TX UE configures too long of a wake-up time for the RX UE, which may not beneficial for power saving, the first UE can send suggested SL DRX configurations to the second UE. In some embodiments, the assistant information includes one of a one or more suggested values of inactivity timer or an one or more allowed/accepted maximum values of the inactivity timer.

In some embodiments, each value of the inactivity timer may associated with a Qos profile. In some embodiments, the assistant information includes one of a one or more suggested values of an on-duration timer or an one or more allowed/accepted maximum values of an on-duration timer. In some embodiments, each value of the on-duration timer may associated a Qos profile. In some embodiments, each value of the on-duration timer may associated with a DRX cycle.

In some embodiments, in step 2, the second UE decides the SL DRX configuration for the first UE. In some embodiments, the second UE determines some parameters of the SL DRX according to the specified rules and determines other parameters of the SL DRX via UE implementation. In some embodiments, if there are multiple QoS profiles associated with multiple DRX cycles, the smallest cycle is to be selected.

Similar to multicast, from the mapping relationship between a system information block (SIB)/pre-configured QoS and cycles, the TX UE can select a cycle. In some embodiments, if there are multiple QoS profiles associated with multiple DRX cycles, the smallest cycle is to be selected. In some embodiments, the RX UE determines the cycle according to the current DRX configuration and QoS requirements, and sends one or more recommended cycles, and then the TX UE selects one of them. In some embodiments, similar to broadcast and multicast, both the TX UE and the RX UE determine the cycle based on QoS, so there is no need to exchange cycle information.

In some embodiments, a DRX on duration depends on the cycle configuration. In some embodiments, there is a one-to-one mapping with SL DRX cycle. In some embodiments, the RX UE sends the assistant information, including one of: one or more suggested values of on-duration timer or one or more allowed/accepted maximum values of on-duration timer. In some embodiments, the TX UE can select one of the one or more suggested/allowed/accepted (maximum) values. In some embodiments, according to the recommended value or range of RX UE, TX UE chooses one of a DRX slot offset/DRX start offset. In some embodiments, the network side provides the range, and the TX UE can select based on the range suggested by the RX UE.

In some embodiments, from the mapping relationship between a SIB/pre-configured inactivity timer and a QoS, the TX UE selects an inactivity value/period. In some embodiments, the RX UE sends one or more recommended cycles according to the current DRX configuration and Qos requirements, and the TX UE selects one of one or more recommended cycles. In some embodiments, similar to broadcast and multicast, both the TX UE and the RX UE determine the inactivity timer according to the QoS.

In some embodiments, the TX UE decides a configured round trip time (RTT) timer by itself and does not distinguish between process and specific value range. In some embodiments, the TX UE decides a configured retransmission timer by itself and does not distinguish between process and specific value range.

In some embodiments, in step 3, the second UE sends the SL DRX configuration to the first UE. In some embodiments, the second UE decides the SL DRX configuration according to its traffic pattern and current SL DRX configuration of the first UE. For example, the second UE determines the SL DRX configurations of the first UE for the link between the first UE and the second UE. In some embodiments, before step1, a first UE considers the default DRX configuration as its SL DRX configuration. Specifically, in some embodiments, if the UE is in coverage, the UE receives a mapping between a QoS requirement and a set of DRX configuration parameters or an index of the set of DRX configuration parameters from the network. In some embodiments, if the UE is out of coverage, the UE preconfigures a mapping between a QoS requirement and a set of DRX configuration parameters or an index of the set of DRX configuration parameters. Then, in some embodiments, the first UE decides the default DRX configuration based on the a QoS requirement.

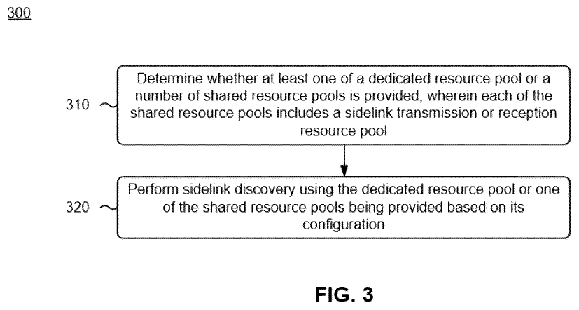

FIG. 3 illustrates a method 300 for performing sidelink discovery, in accordance with some embodiments. Referring to FIGS. 1-2, the method 300 can be performed by a wireless communication device (e.g., a UE) and/or a wireless communication node (e.g., base station, a gNB), in some embodiments. Additional, fewer, or different operations may be performed in the method 300 depending on the embodiment.

In brief overview, in some embodiments, a wireless communication device determines whether at least one of a dedicated resource pool or a number of shared resource pools is provided (operation 310). In some embodiments, the wireless communication device performs sidelink discovery using the dedicated resource pool or one of the shared resource pools being provided based on its configuration (operation 320).

In more detail, at operation 310, in some embodiments, a wireless communication device determines whether at least one of a dedicated resource pool or a number of shared resource pools is provided. In some embodiments, the wireless communication device is a UE. In some aspects, the wireless communication device is a sidelink remote User Equipment (UE) or a sidelink relay UE. In some embodiments, each of the shared resource pools includes a sidelink transmission or reception resource pool

At operation 320, in some embodiments, the wireless communication device performs sidelink discovery using the dedicated resource pool or one of the shared resource pools being provided based on its configuration.

In some aspects, the method includes determining, by the wireless communication device, that no dedicated resource pool is provided; determining, by the wireless communication device, that the shared resource pool being provided is configured to perform the sidelink discovery; and performing, by the wireless communication device, the sidelink discovery using the shared resource pool. In some aspects, the method includes determining, by the wireless communication device, that the dedicated resource pool is provided; determining, by the wireless communication device, that the shared resource pool being provided can be used to perform the sidelink discovery; and performing, by the wireless communication device, the sidelink discovery using any of dedicated resource pool or the shared resource pool.

In some aspects, the method includes determining, by the wireless communication device, that the dedicated resource pool and a Channel Busy Ratio (CBR) threshold are provided; determining, by the wireless communication device, that a (CBR of the dedicated resource pool is lower than the CBR threshold; and performing, by the wireless communication device, the sidelink discovery using the dedicated resource pool and not using any of the shared resource pools. In some aspects, the method includes determining, by the wireless communication device, that the dedicated resource pool and a CBR threshold are provided; determining, by the wireless communication device, that a CBR of the dedicated resource pool is higher than the CBR threshold; and performing, by the wireless communication device, the sidelink discovery using one of the shared resource pools being provided. In some aspects, the method includes receiving, by the wireless communication device, a message indicating the shared resource pool configured to perform the sidelink discovery. In some aspects, the method includes determining, by the wireless communication device, that one of the shared resource pools and a CBR threshold associated with the shared resource pool are provided; determining, by the wireless communication device, that the CBR of the shared resource pool is lower than a CBR threshold; and performing, by the wireless communication device, the sidelink discovery using the shared resource pool.

In some aspects, the method includes determining, by the wireless communication device, that one of the shared resource pools and a CBR threshold associated with the shared resource pool are provided; determining, by the wireless communication device, that a CBR of the shared resource pool is higher than a CBR threshold; and performing, by the wireless communication device, the sidelink discovery without using the shared resource pool. In some aspects, the method includes determining, by the wireless communication device, that the dedicated resource pool is provided; and performing, by the wireless communication device, the sidelink discovery using the dedicated resource pool being provided.

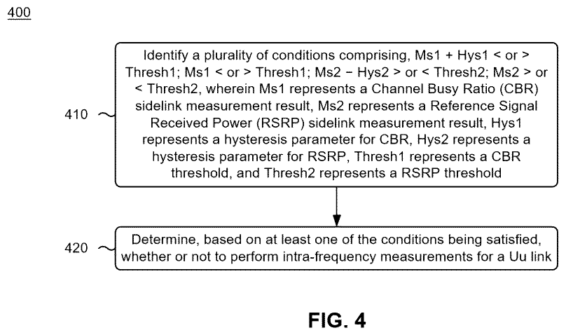

FIG. 4 illustrates a method 400 for determining whether to perform measurements for a Uu link, in accordance with some embodiments. Referring to FIGS. 1-2, the method 400 can be performed by a wireless communication device (e.g., a UE) and/or a wireless communication node (e.g., base station, a gNB), in some embodiments. Additional, fewer, or different operations may be performed in the method 400 depending on the embodiment.

In brief overview, in some embodiments, a wireless communication device provides a plurality of conditions comprising: Ms1+Hys1< or >Thresh1; Ms1< or >Thresh1; Ms2−Hys2> or <Thresh2; Ms2> or <Thresh2 (operation 410). In some embodiments, the wireless communication device determines based on at least one of the conditions being satisfied, whether or not to perform measurements for a Uu link (operation 420).

In more detail, at operation 410, in some embodiments, a wireless communication device provides a plurality of conditions comprising: Ms1+Hys1< or >Thresh1; Ms1< or >Thresh1; Ms2−Hys2> or <Thresh2; Ms2> or <Thresh2. In some embodiments, Ms1 represents a Channel Busy Ratio (CBR) sidelink measurement result, Ms2 represents a Reference Signal Received Power (RSRP) sidelink measurement result, Hys1 represents a hysteresis parameter for CBR, Hys2 represents a hysteresis parameter for RSRP, Thresh1 represents a CBR threshold, and Thresh2 represents a RSRP threshold. In some embodiments, the wireless communication device is a UE. In some embodiments, the wireless communication device is a sidelink remote User Equipment (UE) connected to a sidelink relay UE.

At operation 420, in some embodiments, the wireless communication device determines, based on at least one of the conditions being satisfied, whether or not to perform measurements for a Uu link. In some aspects, identifying, by the wireless communication device, that at least one of the following conditions is satisfied: Ms1<Thresh1; Ms2−Hys2>Thresh2; or Ms2>Thresh2; and determining, by the wireless communication device, not to perform the measurements for the Uu link.

In some aspects, the method includes identifying, by a wireless communication device, that at least one of the following conditions is satisfied: Ms1+Hys1>Thresh1; or Ms1>Thresh1; and determining, by the wireless communication device, to perform the measurements for the Uu link·Ms1>Thresh1. In some aspects, the method includes identifying, by the wireless communication device, that at least one of the following conditions is satisfied: Ms2−Hys2<Thresh2; or Ms2<Thresh2; and determining, by the wireless communication device, to perform the measurements for the Uu link.Ms2<Thresh2; and

In some aspects, the method includes receiving, by the wireless communication device from the relay UE, a message indicating a sidelink Radio Link Failure (RLF); and determining, by the wireless communication device, to perform the measurements for the Uu link. In some aspects, the method includes detecting, by the wireless communication device, a sidelink RLF; and determining, by the wireless communication device, to perform the measurements for the Uu link.

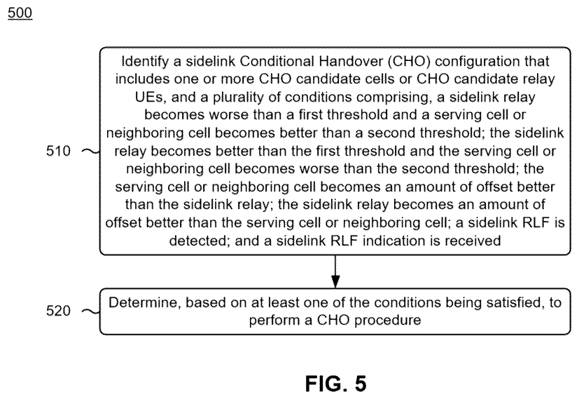

FIG. 5 illustrates a method 500 for determining to perform a CHO procedure, in accordance with some embodiments. Referring to FIGS. 1-2, the method 500 can be performed by a wireless communication device (e.g., a UE) and/or a wireless communication node (e.g., base station, a gNB), in some embodiments. Additional, fewer, or different operations may be performed in the method 500 depending on the embodiment.

In brief overview, in some embodiments, a wireless communication device provides a sidelink Conditional Handover (CHO) configuration that includes one or more CHO candidate cells or CHO candidate relay UEs, and a plurality of conditions comprising: a sidelink relay becomes worse than a first threshold and a serving cell or neighboring cell becomes better than a second threshold; the sidelink relay becomes better than the first threshold and the serving cell or neighboring cell becomes worse than the second threshold; the serving cell or neighboring cell becomes an amount of offset better than the sidelink relay; the sidelink relay becomes an amount of offset better than the serving cell or neighboring cell; a sidelink RLF is detected; and a sidelink RLF indication is received (operation 510). In some embodiments, the wireless communication device determines, based on at least one of the conditions being satisfied, to perform a CHO procedure (operation 520).

In more detail, at operation 510, in some embodiments, a wireless communication device provides a sidelink Conditional Handover (CHO) configuration that includes one or more CHO candidate cells or CHO candidate relay UEs, and a plurality of conditions, the conditions comprising: a sidelink relay becomes worse or better than a first threshold and PCell/PSCell becomes better or worse than a second threshold; PCell/PSCell becomes an amount of offset better than the sidelink relay; the sidelink relay becomes an amount of offset better than the PCell/PSCell; a sidelink RLF is detected; and a sidelink RLF indication is received. In some embodiments, the wireless communication device is a UE. In some embodiments, the wireless communication device is a sidelink remote User Equipment (UE) connected to a sidelink relay UE. In some aspects, the CHO candidate cells can only be the serving cell of the remote UE. In some aspects, the sidelink relay is one of the CHO candidate relay UEs or the sidelink relay is a UE served by the CHO candidate cells.

In some embodiments, the sidelink CHO configuration that includes an indication that all the relay UEs served by the same serving cell include CHO candidate relay UEs. In some embodiments, the sidelink CHO configuration includes one or more CHO candidate cells and wherein all the relay UEs served by the one or more CHO candidate cells can be sidelink CHO candidate relay UEs. In some embodiments, the sidelink CHO configuration, that includes (a) one or more CHO candidate cells and (b) an indication that all the relay UEs served by the one or more CHO candidate cells, can be sidelink CHO candidate relay UEs.

In some aspects, a priority parameter is configured for each of the CHO candidate cells or each of the CHO candidate relay UEs. In some aspects, a priority parameter is configured to indicate that at least one of the CHO candidate relay UEs is prioritized over the CHO candidate cells, or at least one of the CHO candidate cells is prioritized over the CHO candidate relay UEs. In some aspects, the CHO candidate relay UEs served by the same serving cell are prioritized over the CHO candidate cells, or the CHO candidate cells are prioritized over the CHO candidate relay UEs served by different serving cells.

At operation 520, in some embodiments, the wireless communication device determines, based on at least one of the conditions being satisfied, to perform a CHO procedure. In some aspects, determining, by the wireless communication device, that the CHO configuration includes the CHO candidate cells; and determining, by the wireless communication device, that at least one of the following conditions is satisfied so as to perform the CHO procedure: the serving cell or neighboring cell becomes the amount of offset better than the sidelink relay; or the sidelink RLF is detected; or the sidelink RLF indication is received.

In some aspects, the condition that serving cell or neighboring cell becomes an amount of offset better than the sidelink relay includes: the serving cell becomes an amount of a first offset better than the sidelink relay; or the neighboring cell becomes an amount of a second offset better than the sidelink relay. In some aspects, the condition that the sidelink relay becomes an amount of offset better than the serving cell or neighboring cell includes: the sidelink relay becomes an amount of a third offset better than the serving cell; or the sidelink relay becomes an amount of a forth offset better than the neighboring cell.

In some aspects, the condition that a sidelink relay becomes worse than a first threshold and serving cell or neighboring cell becomes better than a second threshold includes: a sidelink relay becomes worse than the first threshold and serving cell becomes better than a third threshold, or a sidelink relay becomes worse than the first threshold and neighboring cell becomes better than a fourth threshold. In some aspects, the conditions that a sidelink relay becomes better than a first threshold and serving cell or neighboring cell becomes worse than a second threshold includes: a sidelink relay becomes better than the first threshold and serving cell becomes worse than a fifth threshold; or a sidelink relay becomes better than the first threshold and neighboring cell becomes worse than a sixth threshold.

In some aspects, determining, by the wireless communication device, that the CHO configuration includes the CHO candidate relay UEs or CHO candidate cells; and determining, by the wireless communication device, that at least one of the following conditions is satisfied so as to perform the CHO procedure: the sidelink relay becomes the amount of offset better than the serving cell; or the sidelink RLF is detected. In some aspects, different one of the CHO candidate relay UEs are associated with different values of the first threshold, or one or more of the CHO candidate relay UEs served by the same serving cell are associated with a first value of the first threshold and one or more of the candidate relay UEs served by a non-serving cell are associated with a second value of the first threshold.

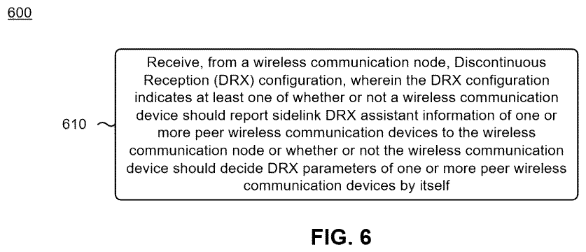

FIG. 6 illustrates a method 600 for receiving a Discontinuous Reception (DRX) configuration, in accordance with some embodiments. Referring to FIGS. 1-2, the method 600 can be performed by a wireless communication device (e.g., a UE) and/or a wireless communication node (e.g., base station, a gNB), in some embodiments. Additional, fewer, or different operations may be performed in the method 600 depending on the embodiment.

In some embodiments, a wireless communication device receives, from a wireless communication node, Discontinuous Reception (DRX) configuration (operation 610). In some embodiments, the DRX configuration indicates at least one of: whether or not the wireless communication device should report sidelink DRX assistant information of one or more peer wireless communication devices to the wireless communication node; or whether or not the wireless communication device should decide DRX parameters of one or more peer wireless communication devices by itself. In some embodiments, the wireless communication device is a UE and the wireless communication node is a BS (e.g., a gNB).

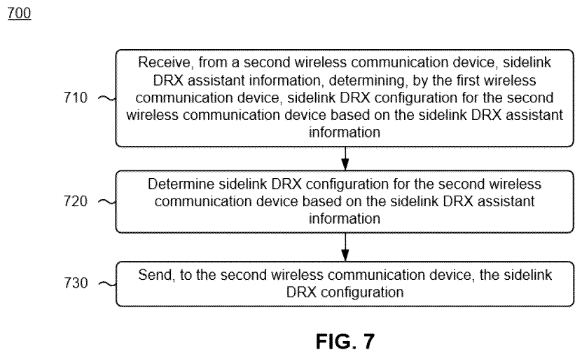

FIG. 7 illustrates a method 700 for determining sidelink DRX configuration, in accordance with some embodiments. Referring to FIGS. 1-2, the method 700 can be performed by a first wireless communication device (e.g., a UE) and/or a wireless communication node (e.g., base station, a gNB), in some embodiments. Additional, fewer, or different operations may be performed in the method 700 depending on the embodiment.

In brief overview, in some embodiments, a first wireless communication device receives, from a second wireless communication device, sidelink DRX assistant information (operation 710). In some embodiments, the first wireless communication device determines sidelink DRX configuration for the second wireless communication device based on the sidelink DRX assistant information (operation 720). In some embodiments, the first wireless communication device sends, to the second wireless communication device, the sidelink DRX configuration (operation 730). In some embodiments, the first wireless communication device is a UE (e.g., the second UE, the peer UE) and the second wireless communication device is a UE (e.g., the first UE).

In greater detail, at operation 710, in some embodiments, a first wireless communication device receives, from a second wireless communication device, sidelink DRX assistant information. In some embodiments, the first wireless communication device is a UE (e.g., the second UE, the peer UE) and the second wireless communication device is a UE (e.g., the first UE).

In some aspects, the sidelink DRX assistant information includes one or more DRX cycles, the method further comprises: selecting, by the first wireless communication device, one of the one or more DRX cycles provided in the sidelink DRX assistant information. In some aspects, the sidelink DRX assistant information includes at least one of: suggested values of an on-duration timer for one or more DRX cycles, or one or more allowed/accepted maximum values of the on-duration timer for one or more DRX cycles, the method further comprising: selecting, by the first wireless communication device, one or more on-duration timers for the one or more DRX cycles based on the sidelink DRX assistant information.

In some aspects, the sidelink DRX assistant information includes at least one of: a range of a DRX slot offset or a range of a DRX start offset for one or more DRX cycles, the method further comprising: selecting, by the first wireless communication device, the DRX slot offset or the DRX start offset for one or more DRX cycles based on the sidelink DRX assistant information. In some aspects, the sidelink DRX assistant information includes a plurality of ranges of an inactivity timer for one or more DRX cycles, the method further comprising: selecting, by the first wireless communication device, the inactivity timer for one or more DRX cycles based on the sidelink DRX assistant information.

At operation 720, in some embodiments, the first wireless communication device determines sidelink DRX configuration for the second wireless communication device based on the sidelink DRX assistant information. In some aspects, sending, by the first wireless communication device to the second wireless communication device, a SL DRX MAC CE when at least one of the following conditions is satisfied: after the first wireless communication device reconfigures the sidelink DRX configuration for the second wireless communication device; or there are N slots/ms that have not been used to transmit data.

In some aspects, the method includes stopping, by the first wireless communication device or the second wireless communication device, drx-onDurationTimer for a PC5 link between the first and second wireless communication devices; stopping, by the first wireless communication device or the second wireless communication device, drx-InactivityTimer for the PC5 link; using, by the first wireless communication device, the DRX configuration for the PC5 link; or using, by the first wireless communication device or the second wireless communication device, the updated sidelink DRX configuration for the PC5 link.

At operation 730, in some embodiments, the first wireless communication device sends, to the second wireless communication device, the sidelink DRX configuration. In some aspects, the network provides at least one of: maximum values or minimum values or allowed sets of the on-duration timer or for each DRX cycles; maximum values or minimum values or allowed sets of a DRX slot offset for each of the one or more DRX cycles; maximum values or minimum values or allowed sets of a DRX start offset for each of the one or more DRX cycles; or maximum values or minimum values or allowed sets of an inactivity timer for each of the one or more DRX cycles; the method further comprising selecting, by the first wireless communication device, on-duration timer or DRX slot offset or DRX start offset or an inactivity timer based on the configuration for each of the one or more DRX cycles provided by the network.

In some aspects, the method includes determining, by the first wireless communication device, a configured Round-Trip Time (RTT) timer according a specified range. In some aspects, the method includes determining, by the first wireless communication device, a configured retransmission timer according a specified range.

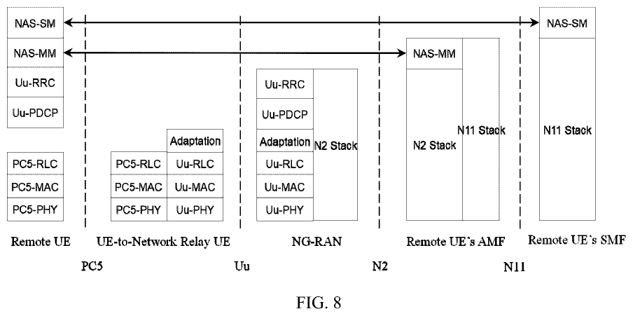

FIG. 8 illustrates an end-to-end control plane for a remote UE using layer-2 UE-to-network relay, in accordance with some embodiments. In some embodiments, in layer-2 sidelink relay, remote UE will establish RRC connection with gNB via relay UE. In this case, gNB can recognize/determine/identify the remote UE and send control signaling to remote UE. The protocol of layer-2 relay is illustrated in FIG. 8.

As shown in FIG. 8, a packet data convergence protocol (PDCP) is terminated between a remote UE and a Next Generation radio access network (NG-RAN). Different from PRCP, a radio link control (RLC) is terminated hop by hop. In some embodiments, an adaptation layer is supported over PC5 or Uu or the adaptation layer can be terminated between the remote UE and the NG-RAN.

In some embodiments, although the medium access control (MAC) entity is terminated hop by hop, some medium access control element (MAC CE) still needs to be forwarded to the remote UE such as a recommended bit rate MAC CE to control the transmission bit rate of higher layer application. To forward the MAC CE by the NG-RAN to the remote UE or to forward the MAC CE by the remote UE to the NG-RAN, a number of options may be used.

In some embodiments the MAC CE is forwarded by MAC layer. In some embodiments, a MAC sub-protocol data unit (subPDU) in a Uu MAC PDU includes one indication that indicates this MAC CE is to be forwarded to remote UE. In some embodiments, the MAC subPDU in the Uu MAC PDU includes one indication that indicates this MAC CE belongs to/is associated with/mapped to a certain remote UE (e.g., the remote UE). That is, in some embodiments, the MAC subPDU in the Uu MAC PDU includes one indication that indicates which remote UE (e.g., the remote UE) this MAC CE belongs to. In some embodiments, the MAC subPDU in a PC5 MAC PDU includes a new logical channel identifier/identification (LCID) indicates that this MAC CE is a Uu MAC CE. In some embodiments, the MAC subPDU in the PC5 MAC PDU includes a new LCID indicates that this MAC CE is (e.g., associated with, mapped to) a certain Uu MAC CE. In some embodiments, the MAC subPDU in the PC5 MAC PDU includes the Uu MAC subPDU.

In some embodiments, the MAC subPDU in the PC5 MAC PDU includes one indication that indicates this MAC CE is to be forwarded to NG-RAN. In some embodiments, the MAC subPDU in Uu MAC PDU includes a new LCID indicates that this MAC CE is from the remote UE. In some embodiments, the MAC subPDU in the Uu MAC PDU includes a new LCID indicates that this MAC CE is from a certain remote UE.

In some embodiments, the RRC signaling from the NG-RAN to the remote UE includes the Uu MAC subPDU. In some embodiments, the RRC signaling from the remote UE to the NG-RAN includes the PC5 MAC subPDU. In some embodiments, for the scenario of centralized unit (CU)-distributed unit (DU) split, and for the case in which the NG-RAN can transmit the MAC CE to the remote UE, the CU forwards the MAC subPDU to the DU and indicates this MAC subPDU belongs to a certain remote UE. In some embodiments, for the scenario of CU-DU split, and for the case remote UE can transmit the MAC CE to NG-RAN, the DU forwards the received MAC subPDU to the CU and indicates this MAC subPDU belongs to a certain remote UE. In some embodiments, the DU indicates to the CU whether the transmission of MAC subPDU is successful or not.

In some embodiments, for the case that adaptation layer is hop by hop, the adaption layer includes one or more indications. In some embodiments, the adaptation layer PDU over the Uu interface includes an indication that indicates this adaptation layer PDU is a MAC CE. In some embodiments, the adaptation layer PDU over the PC5 interface includes an indication that indicates this adaptation layer PDU is a MAC CE. In some embodiments, the adaptation layer PDU over the Uu interface includes an indication that indicates this adaptation layer PDU is a certain MAC CE. In some embodiments, the adaptation layer PDU over the PC5 interface includes an indication that indicates this adaptation layer PDU is a certain MAC CE.

In some embodiments, for the case that adaptation layer is end-to-end (e.g., between the remote UE and the NG-RAN), the adaption layer includes one or more indications. In some embodiments, the adaptation layer PDU includes an indication that indicates this adaptation layer PDU is a MAC CE. In some embodiments, the adaptation layer PDU includes an indication that indicates this adaptation layer PDU is a certain MAC CE.

In some embodiments, in a (e.g., normal) Uu PDCP entity, a discard timer is configured to the UE and if the discard timer expiry, the PDCP of the UE discards the stored PDCP PDU. However, in some embodiments of sidelink relay, for the relay UE, the PDCP layer is not supported over the PC5 interface and the Uu interface, as shown in FIG. 8. In some embodiments, therefore, the relay UE does not know/determine when to discard the remote UE's packet. In some embodiments, the relay UE is configured with a packet delay budget (PDB) value or a discard timer. In some embodiments, the PDB value or the discard timer is configured per a logical channel, an RLC channel, an RLC bearer, or a priority.

In some embodiments, the relay UE discards the data belonging to one logical channel, RLC channel, or RLC bearer once the corresponding discard timer expiry or the corresponding PDB cannot be ensured. In some embodiments, the relay UE starts the discard timer once the relay UE receives the data from upper layer. In some embodiments, the PC5 RLC channel starts the discard timer once the PC5 RLC receives the data from upper layer. In some embodiments, the PC5 RLC bearer starts the discard timer once the PC5 RLC bearer receives the data from upper layer. In some embodiments, the PC5 logical channel starts the discard timer once the PC5 logical channel receives the data from upper layer. In some embodiments, the Uu RLC channel starts the discard timer once the Uu RLC channel receives the data from upper layer. In some embodiments, the Uu RLC bearer starts the discard timer once the Uu RLC bearer receives the data from upper layer. In some embodiments, the Uu logical channel starts the discard timer once the Uu logical channel receives the data from upper layer. In some embodiments, the PC5 RLC channel is configured with a PDB value or discard timer.

In some embodiments, the PC5 RLC bearer is configured with a PDB value or discard timer. In some embodiments, the PC5 logical channel is configured with a PDB value or discard timer. In some embodiments, the Uu RLC channel is configured with a PDB value or discard timer. In some embodiments, the Uu RLC bearer is configured with a PDB value or discard timer. In some embodiments, the Uu logical channel is configured with a PDB value or discard timer.

In some embodiments, for a remote UE using sidelink relay, it can only use mode2(select resource by itself) to transmit it's Uu data to relay UE. In some embodiments, during resource selection, the UE is to ensure the remaining PDB. Some embodiments randomly select the time and frequency resources for one transmission opportunity from the resources indicated by the physical layer, according to the amount of selected frequency resources and the remaining PDB of SL data available in the logical channel(s) allowed on the carrier.

In some embodiments, for a remote UE, however, the PDB obtained from remote UE's upper layer is an overall end-to-end (E2E) PDB, and the E2E PDB can be divided into a PC5 part/portion of the PDB and a UU part/portion of the PDB. In some embodiments, to ensure the E2E PDB, the remote UE is to select the resources according to the remaining PC5 part of the PDB, not the overall E2E PDB.

In some embodiments, the remote UE is configured with a PC5 part of the PDB value. In some embodiments, the configured PC5 part of the PDB value is per a logical channel, RLC channel, an RLC bearer, or a priority. In some embodiments, the remaining PDB of SL data forwarded to the relay UE is calculated based on the configured PC5 part of the PDB value.

In some embodiments, relay UE is configured with a PC5 part of the PDB value. In some embodiments, the configured PC5 part of the PDB value is per a logical channel, RLC channel, an RLC bearer, or a priority. In some embodiments, the remaining PDB of SL data forwarded to the relay UE is calculated based on the configured PC5 part of the PDB value.

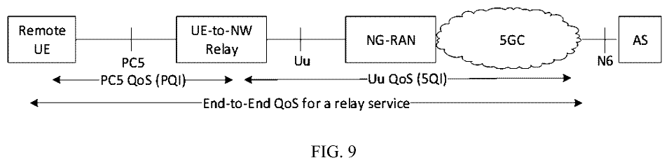

FIG. 9 illustrates end-to-end QoS translation for Layer 3 UE-to-network relay, in accordance with some embodiments. In some embodiments, for a layer-3 relay, the relay UE forwards the remote UE's traffic by IP layer. In some embodiments, the end-to-end QoS can be divided into two parts, a PC5 part and a Uu part. The corresponding QoS of the PC5 part and the Uu part is controlled by PC5 QoS/QoS flow indicator (PQI) and 5G QoS/QoS flow indicator (5QI), respectively. To ensure the end-to-end QoS, a mapping between the PQI and the 5QI is configured to relay UE.

However, the current standardized PQIs were defined with relaxed PDBs, assuming that the service terminates between the two UEs directly. For example, PQI=24 has a PDB of 150 ms instead of the 75 ms for 5QI=65. In some embodiments, the PQI is to be adjusted in order to be useful for the UE-to-Network Relay use. For example, the QoS mapping may include a general adjustment factor of 5 for the PDBs. In that case, in some embodiments, when PQI=24 is used, the PDB over PC5 will be adjusted to 30 ms (⅕ of original PDB). Therefore, in some embodiments, in addition to the PQI and 5QI mapping, a PDB adjustment factor is configured to the relay UE.

In some embodiments, for PC5 communication, the relay UE is to report the Stanford University Interim (SUI) including a QoS profile to the gNB for obtaining the PC5 RB configuration. Thus, in some embodiments, to meet the end-to-end QoS, the relay UE is to report the adjusted Packet Delay Budget (PDB) to the gNB.

In some embodiments, the relay UE reports the PDB adjustment factor to the gNB. In some embodiments, the reported PDB adjustment factor is per the QoS profile. In some embodiments, the relay UE reports the adjusted PDB to the gNB. In some embodiments, the reported adjusted PDB is per the QoS profile. In some embodiments, the reported adjusted PDB is per a relay service code. In some embodiments, the relay UE reports the PDB adjustment factor to the remote UE. In some embodiments, the reported PDB adjustment factor is per the QoS profile. In some embodiments, the relay UE reports the adjusted PDB to the remote UE. In some embodiments, the relay UE modifies the PC5 QoS parameters after receiving the PDB adjustment factor.

In some embodiments, to ensure the E2E QOS of remote UE, the relay UE is to associate the PC5 QoS flow and the Uu QoS flow, such that the overall QoS requirements can be met by combining the PC5 QoS flow and the Uu QoS flow. Thus, in some embodiments, after receiving the packets from the remote UE or the gNB, the relay UE is to identify the packet that belongs to a certain QoS flow, so that the relay UE can find the corresponding QoS flow in the other side. However, in some embodiments, the QoS flow identifier (QFI) or the PC5 flow identifier (PFI) is configured by the UE or the gNB.

In some embodiments of the PC5 interface, for data from the remote UE to the relay UE, the remote UE does not know/determine whether the relay UE will associate the PC5 QoS flow to the Uu QoS flow. Thus, in some embodiments, the remote UE may not always configure the QFI in a service data adaption protocol (SDAP) header. In some embodiments of the Uu interface, for data from the gNB to the relay UE, the gNB is not aware of/does not determine the remote UE's traffic and may also not configure the QFI in the Uu SDAP header.

Some embodiments of a solution to the foregoing problem are disclosed herein. In some embodiments, the relay UE sends an indication to the remote UE that the QFI or the SDAP header is to be present. In some embodiments, this indication can be per the QoS flow, the data radio bearer (DRB), the RLC bearer, or the RLC channel. In some embodiments, the relay UE sends an indication to the gNB that the QFI or the SDAP header is to be present. In some embodiments, this indication can be per the QoS flow, the DRB, the RLC bearer, or the RLC channel. In some embodiments, this indication can be per the destination.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of some embodiments described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
determining, by a wireless communication device, whether at least one of a dedicated resource pool or a number of shared resource pools is provided, wherein each of the shared resource pools includes a sidelink transmission or reception resource pool; and
performing, by the wireless communication device, sidelink discovery using the dedicated resource pool or one of the shared resource pools being provided based on its configuration.

2. The wireless communication method of claim 1, further comprising:
determining, by the wireless communication device, that no dedicated resource pool is provided;
determining, by the wireless communication device, that the shared resource pool being provided is configured to perform the sidelink discovery; and
performing, by the wireless communication device, the sidelink discovery using the shared resource pool.

3. The wireless communication method of claim 1, further comprising:
determining, by the wireless communication device, that the dedicated resource pool is provided;
determining, by the wireless communication device, that the shared resource pool being provided can be used to perform the sidelink discovery; and
performing, by the wireless communication device, the sidelink discovery using any of dedicated resource pool or the shared resource pool.

4. The wireless communication method of claim 1, further comprising:
determining, by the wireless communication device, that the dedicated resource pool and a Channel Busy Ratio (CBR) threshold are provided;
determining, by the wireless communication device, that a CBR of the dedicated resource pool is lower than the CBR threshold; and
performing, by the wireless communication device, the sidelink discovery using the dedicated resource pool and not using any of the shared resource pools.

5. The wireless communication method of claim 1, further comprising:
determining, by the wireless communication device, that the dedicated resource pool and a Channel Busy Ratio (CBR) threshold are provided;
determining, by the wireless communication device, that a CBR of the dedicated resource pool is higher than the CBR threshold; and
performing, by the wireless communication device, the sidelink discovery using one of the shared resource pools being provided.

6. The wireless communication method of claim 5, further comprising:
receiving, by the wireless communication device, a message indicating the shared resource pool configured to perform the sidelink discovery.

7. The wireless communication method of claim 1, further comprising:
determining, by the wireless communication device, that one of the shared resource pools and a Channel Busy Ratio (CBR) threshold associated with the shared resource pool are provided;
determining, by the wireless communication device, that the CBR of the shared resource pool is lower than the CBR threshold; and
performing, by the wireless communication device, the sidelink discovery using the shared resource pool.

8. The wireless communication method of claim 1, further comprising:
determining, by the wireless communication device, that one of the shared resource pools and a Channel Busy Ratio (CBR) threshold associated with the shared resource pool are provided;
determining, by the wireless communication device, that a CBR of the shared resource pool is higher than the CBR threshold; and
performing, by the wireless communication device, the sidelink discovery without using the shared resource pool.

9. The wireless communication method of claim 7, further comprising:
determining, by the wireless communication device, that the dedicated resource pool is provided; and
performing, by the wireless communication device, the sidelink discovery using the dedicated resource pool being provided.

10. The wireless communication method of claim 1, wherein the wireless communication device is a sidelink remote User Equipment (UE) or a sidelink relay UE.

11. A wireless communication device, comprising:
at least one processor configured to:
determine whether at least one of a dedicated resource pool or a number of shared resource pools is provided, wherein each of the shared resource pools includes a sidelink transmission or reception resource pool; and
perform sidelink discovery using the dedicated resource pool or one of the shared resource pools being provided based on its configuration.

12. The wireless communication device of claim 11, wherein the at least one processor is configured to:
determine that no dedicated resource pool is provided;
determine that the shared resource pool being provided is configured to perform the sidelink discovery; and
perform the sidelink discovery using the shared resource pool.

13. The wireless communication device of claim 11, wherein the at least one processor is configured to:
determine that the dedicated resource pool is provided;
determine that the shared resource pool being provided can be used to perform the sidelink discovery; and
perform the sidelink discovery using any of dedicated resource pool or the shared resource pool.

14. The wireless communication device of claim 11, wherein the at least one processor is configured to:
determine that the dedicated resource pool and a Channel Busy Ratio (CBR) threshold are provided;
determine that a CBR of the dedicated resource pool is lower than the CBR threshold; and
perform the sidelink discovery using the dedicated resource pool and not using any of the shared resource pools.

15. The wireless communication device of claim 11, wherein the at least one processor is configured to:
determine that the dedicated resource pool and a Channel Busy Ratio (CBR) threshold are provided;
determine that a CBR of the dedicated resource pool is higher than the CBR threshold; and
perform the sidelink discovery using one of the shared resource pools being provided.

16. The wireless communication device of claim 15, wherein the at least one processor is configured to:
receive, via a receiver, a message indicating the shared resource pool configured to perform the sidelink discovery.

17. The wireless communication device of claim 11, wherein the at least one processor is configured to:
determine that one of the shared resource pools and a Channel Busy Ratio (CBR) threshold associated with the shared resource pool are provided;
determine that the CBR of the shared resource pool is lower than the CBR threshold; and
perform the sidelink discovery using the shared resource pool.

18. The wireless communication device of claim 11, wherein the at least one processor is configured to:
determine that one of the shared resource pools and a Channel Busy Ratio (CBR) threshold associated with the shared resource pool are provided;
determine that a CBR of the shared resource pool is higher than the CBR threshold; and
perform the sidelink discovery without using the shared resource pool.

19. The wireless communication device of claim 17, wherein the at least one processor is configured to:
determine that the dedicated resource pool is provided; and
perform the sidelink discovery using the dedicated resource pool being provided.

20. The wireless communication device of claim 11, wherein the wireless communication device is a sidelink remote User Equipment (UE) or a sidelink relay UE.
